(19) United States
(12) Patent Application Publication
(10) Pub. No.: US 2006/0036519 A1
(43) Pub. Date: Feb. 16, 2006

(54) Method and system for sales and use tax administration allowing for online and real-time compliance monitoring and assurance

(76) Inventors: Clemens A. Pfeiffer, Santa Clara, CA (US); Ting Hui, Santa Clara, CA (US)

Correspondence Address: Clemens A. Pfeiffer, 2394 Walsh Avenue, Santa Clara, CA, 95051, US

(21) Appl. No.: 11/176,750

(22) Filed: Jul. 7, 2005

Related U.S. Application Data
(60) Provisional application No. 60/587,524, filed on Jul. 13, 2004.

(51) Int. Cl. G07B 17/00; G07F 19/00

(52) U.S. Cl. 705/30; 705/31

(57) ABSTRACT

The present invention provides a method and system for sales and use tax administration comprising the steps of: 1. Transferring sales and use tax rates in electronic form into a business' accounting system; 2. Reconciling a business'a. Sales and use tax obligation based on the rates transferred in step 1, b. Revenues from sales and expenses from purchases that create the tax obligation in step 2.a, c. Sales tax collected on sales and use tax accrued on purchases in step 2.b, d. Payments of taxes collected and accrued in step 2.c; 3. Electronically filing tax returns and transferring electronic funds on a monthly and quarterly after the reconciliation in step 2. 4. Real time monitoring and visibility. In a certain embodiment of this invention, a system exists for setting up a schedule to perform the steps in the method above continuously and automatically according to said schedule Also, this invention fulfills the above-described needs in the art by providing a method for monitoring online and in real-time the steps in the method above as performed according to the previous schedule. In addition, this invention further fulfills the above-described needs in the art by providing a method for storing and retrieving the monitoring compliance data. In a certain embodiment of this invention, the above method further comprises steps for setting up rules to identify exceptions when the steps in the above method are performed according to the previous schedule and monitored, using data stored and retrievable according to the description above. In another embodiment of this invention, a system is provided for communicating exceptions to initiate human intervention. In certain further embodiments of this invention, the above method and system for sales and use tax administration has the flexibility for adaptation to other types of transaction taxes, which include, but are not limited to value added tax (VAT), goods and services tax (GST), provincial sates tax (PST), harmonized sates tax (HST), lease and rental taxes, telecom taxes, and excise taxes.

### CROSS-REFERENCE TO RELATED APPLICATIONS

This application claims the benefit of provisional patent application Ser. No. 60/587524, filed 2004 Jul. 12 by the present inventor.

### BACKGROUND OF THE INVENTION

1. Field of the Invention

This present invention relates to a method for sales and use tax administration. Moreover, this invention pertains specifically to a method and system for sales and use tax administration allowing for online and real-time compliance monitoring and assurance.

2. Description of Related Art

Tax laws in the United States stipulate that all sell and buy transactions and the amount of tax collected or accrued on these transactions are reported to state and local government authorities. Most state and local governments levy a percentage-based tax on such transfer of tangible personal property. Sales and use tax rates and the rules for taxing goods and services vary from state to state.

Various methods and systems have been developed in the field of either sales or use tax administration.

U.S. Pat. No. H1,830 discloses an invention that relates to computer-implemented tax preparation and tax submission accounting, and the invention is directed to providing a system, which enables use-tax accrual and determination.

U.S. Pat. No. 5,875,433 discloses a point of sale tax reporting and automatic collection system including a smart tax register located at a retailer location.

U.S. Pat. No. 5,335,169 discloses a computerized system for tracking multiple types of sales tax assessments for different taxing authorities on different types of sales transactions with customers.

While various methods and systems have been developed in the field of either sales or use tax administration, there remains a need in the art for a method and system to facilitate the calculation of the tax on buy and sell transaction, the internal reconciliation of tax obligation and corporate financials, and monthly and quarterly filing of tax returns and remittance of payments.

In addition, there is a need for a method and system for setting up a schedule to perform these steps continuously and automatically according to said schedule. Also, there is a need for a method and system to monitor and assure sales and use tax compliance as performed according to the above schedule, as well as for storing and retrieving this compliance monitoring and assurance data.

Moreover, there is a need for a method and system for setting up rules to identify exceptions when the above tax rating and reporting steps are performed according to the above schedule, using compliance monitoring and assurance data stored and retrievable. In addition, there is a need for a method and system for communicating the above exceptions to initiate human intervention.

### SUMMARY OF THE INVENTION

In view of the limitations in the prior art, the present invention provides a new and useful method and system for sales and use tax administration, which is simpler in deployment, more universally usable, and more versatile in operation than known methods and systems of this kind, and which solves some of the problems associated with sales and use tax administration.

The purpose of the present invention is to provide a new, end-to-end method and system for sales and use tax administration that has many novel features and advantages not offered by the prior art, including allowing updating tax rates, auditing of transactions, and reporting collections and accruals to state and local governments. The result is a new method and system for sales and use tax administration, which is not apparent, obvious, or suggested, either directly or indirectly by any of the prior art.

In one aspect, the present invention fulfills the above described needs in the art by providing a method and system for sales and use tax administration comprising the steps of:
1. Transferring sales and use tax rates in electronic form into a business' accounting system;
2. Reconciling a business'
   a. Sales and use tax obligation based on the rates transferred in step 1,
   b. Revenues from sales and expenses from purchases that create the tax obligation in step 2.a,
   c. Sales tax collected on sales and use tax accrued on purchases in step 2.b,
   d. Payments of taxes collected and accrued in step 2.c;
3. Electronically filing tax returns and transferring electronic funds on a monthly and quarterly schedule after the reconciliation in step 2.

In another aspect, the present invention embodies a system for setting up a schedule to perform the steps in the method above continuously and automatically according to said schedule. Also, this invention fulfills the above-described needs in the art by providing a system for monitoring online and in real-time the steps in the method above as performed according to the previous schedule. In addition, this invention further fulfills the above-described needs in the art by providing a method and system for storing and retrieving the monitoring compliance data.

In a certain embodiment of this invention, the above method further comprises steps for setting up rules to identify exceptions when the steps in the above method are performed according to the previous schedule and monitored, using data stored and retrievable according to the description above. In another embodiment of this invention, a system is provided for communicating exceptions to initiate human intervention.

In certain further embodiments of this invention, the above method and system for sales and use tax administration has the flexibility for adaptation to other types of transaction taxes, which include, but are not limited to value added tax (VAT), goods and services tax (GST), provincial sales tax (PST), harmonized sales tax (HST), lease and rental taxes, telecom taxes, and excise taxes.

The foregoing has outlined the general aspects of the invention and is to serve as an aid to better understand the more complete detailed description, which is to follow. In reference to such, there is to be a clear understanding that the present invention is not limited to the method or detail of deployment, software, hardware, or application of use described and illustrated herein. Any other variation of deployment, use, or application should be considered apparent as an alternative embodiment of the present invention.

This invention will now be described with reference to certain embodiments thereof as illustrated in the following drawings. Further objects and advantages of the invention will become apparent from the following description.

To generalize, it is a purpose of this invention to fulfill the above-described needs, as well as other needs apparent to the skilled artisan from the following detailed description of this invention.

### BRIEF DESCRIPTION OF THE DRAWINGS

The attached drawing further describes by illustration the advantages and objects of the present invention.

FIG. 1 is a process view of a method and system for sales and use tax administration according to the present invention.

### DETAILED DESCRIPTION OF THE INVENTION

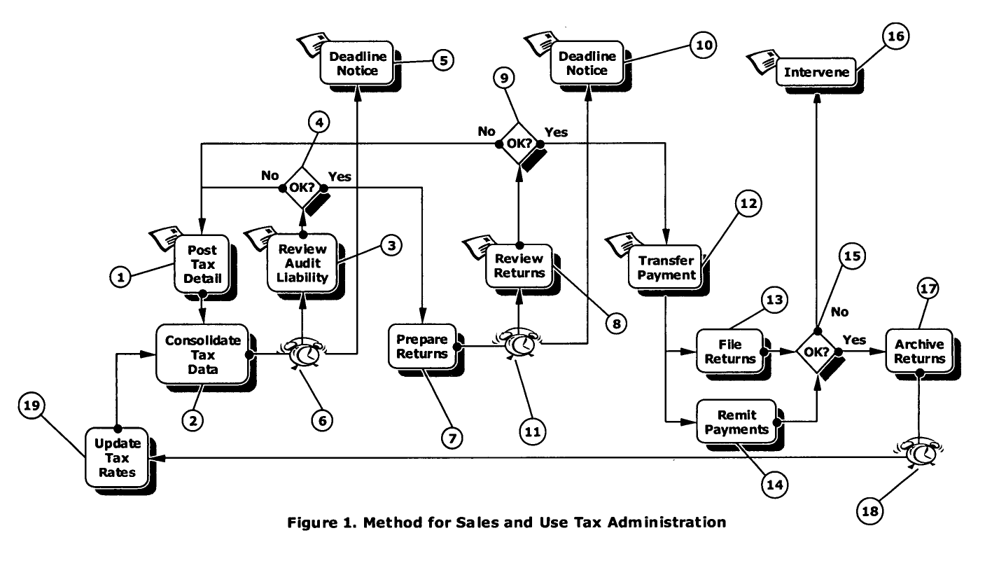

Referring now descriptively to the drawing, the attached FIG. 1 illustrates a method and system for sales and use tax administration according to the present invention.

The method and system begin when a business' tax department posts its sales and use tax detail (1). In one embodiment, the tax detail is contained in a text file and the personnel in the tax department upload the file to a Web-browser accessible Internet site.

The method and system subsequently invoke an operation to consolidate the tax data (2) in preparation for filing. In one embodiment, a software program performs the consolidation operation.

Following the consolidation, personnel in the tax department review the business' audit liability (3), which are the total sales and use tax collections that the business is required to remit to the appropriate tax authorities.

If the tax department approves the consolidated tax data (4), the method and system takes over and initiates the returns preparation process (7); if not, the tax department reviews the business' tax detail, makes corrections as appropriate, and uploads the data again (1). The review process is controlled by a method and system maintained timer (6), which generates a deadline notice (5) if the review process exceeds the allotted time.

The method and system generate all the appropriate forms required for filing the collected taxes with the tax authorities, and, again, submits the tax returns for review (8). If the returns have been approved, the method and system will proceed to filing (12) and payment (13) process. If not approved (9), the tax department can again review the business' tax detail and restart the upload and subsequent review process. As before, the method and system offer an internal control that times (11) the return review process, and that generates a deadline notice if the review exceeds the allotted time (10).

In one embodiment of the method and system, the returns are filed electronically with the tax authorities according to the filing schedule that represents the dates at which each authority expects to receive the returns. Likewise, in one embodiment, the collected and accrued taxes are transferred to the authorities treasuries using an electronic funds transfer mechanism. If the authorities acknowledge receipt of the filings and funds, the method and system and perform two additional steps.

The first step is the archival of the returns (17). In one embodiment, this archive is a database system, and the returns are electronically archived for storage and retrieval. The second step is an update of the sales and use tax rates (19) that the business' order processing organization uses to make its tax decisions. The method and system control the tax rate update process so that the order-processing department uses the most recent tax rates following the accounting period for which the method and system prepared the tax returns

If the tax authorities do not acknowledge receipt of filings and payments, the tax department will receive a notice to manual intervene.

Collectively, the steps outlined demonstrate and an embodiment of a method and system for sales use tax administration allowing for online and real-time compliance monitoring and assurance.

Once given the above disclosure, therefore, various other modifications, features, or improvements will become apparent to the skilled artisan. Such other features, modifications, and improvements are thus considered a part of this invention, the scope of which is to be determined by the appended claims and their legal equivalents.

We claim:

1. A method to facilitate the calculation of the tax on buy and sell transaction, the internal reconciliation of tax obligation and corporate financials, and monthly and quarterly filing of tax returns and remittance of payments.

2. The method of claim 1 wherein said the calculation of the tax and the filing of tax returns can be done by setting up a schedule to perform continuously and automatically according to said schedule.

3. The method of claim 1 wherein said a system for monitoring online and in real time storing and retrieving the monitoring compliance data according to the schedule.

4. The closure of claim 1 wherein said the method and system for sales and use tax administration has the flexibility for adaptation to other types of transaction taxes.

5. A method for administering tax on sell and buy transactions comprising the steps to provide a system for sales and use tax administration.

6. The method of claim 5 wherein said transferring sales and use tax rates in electronic form into a business' accounting system.

7. The method of claim 5 wherein said reconciling a business' sales and use tax obligation based on the rates transferred in claim 6.

8. The method of claim 5 wherein said reconciling a business' revenues from sales and expenses from purchases that create the tax obligation in claim 7.

9. The method of claim 5 wherein said reconciling a business' sales tax collected on sales and use tax accrued on purchases in claim 8.

10. The method of claim 5 wherein said reconciling a business' payments of taxes collected and accrued in claim 9.

11. A method for administering tax automatically in real time according to said schedule and the rules.

12. The method of claim 11 wherein said electronically filing tax returns and transferring electronic funds on a monthly, quarterly or otherwise pre-defined schedule.

13. The method of claim 11 wherein said setting up a schedule to continuously and automatically perform the method in claim 12 according to said schedule.

14. The method of claim 11 wherein said monitoring online and in real-time the method of claim 11 as performed according to the schedule in claim 13.

15. The method of claim 11 wherein said storing and retrieving the monitoring data in claim 14.

16. The method of claim 11 wherein said the system for setting up rules to identify exceptions when the method of claim 11 are performed according to the schedule in claim 13 and monitored according to claim 14, using data stored and retrievable according to claim 15.

17. The method of claim 16 wherein said communicating exceptions initiate human intervention.

18. The method of claim 11 herein said taxes are other transaction taxes, which include, but are not limited to
a. Value added tax (VAT)
b. Goods and services tax (GST)
c. Provincial sales tax (PST)
d. Harmonized sales tax (HST)
e. Lease and rental taxes
f. Telecom taxes
g. Excise taxes.
